(19) United States
(12) Patent Application Publication
(10) Pub. No.: US 2015/0125764 A1
(43) Pub. Date: May 7, 2015

(54) Flow Battery Using Non-Newtonian Fluids

(71) Applicant: Massachusetts Institute of Technology, Cambridge, MA (US)

(72) Inventors: Kyle Christopher Smith, Cambridge, MA (US); W. Craig Carter, Jamaica Plain, MA (US); Yet-Ming Chiang, Weston, MA (US)

(73) Assignee: Massachusetts Institute of Technology, Cambridge, MA (US)

(21) Appl. No.: 14/514,954

(22) Filed: Oct. 15, 2014

Related U.S. Application Data
(60) Provisional application No. 61/892,588, filed on Oct. 18, 2013.

(51) Int. Cl. H01M 8/04; H01M 8/18; C25B 1/00; C25F 7/00; C25F 3/02; C02F 1/469; H01M 8/20; H01M 12/08

(52) U.S. Cl. CPC H01M 8/04746; H01M 8/20; H01M 8/188; H01M 12/08; C25F 7/00; C25F 3/02; C02F 1/4691; C25B 1/003; C02F 2201/46
USPC 429/406; 429/443; 204/219; 204/674

(57) ABSTRACT

Flow battery. The battery includes high energy density fluid electrodes having a selected non-Newtonian rheology and structure for providing intermittent flow pulses of controlled volume and duration of the fluid electrodes, the structure adapted to promote interfacial slip to improve flow uniformity. The battery disclosed herein provides a potential solution to large-scale electrical energy storage needs.

This application claims priority to provisional application Ser. No. 61/892,588 filed on Oct. 18, 2013, the contents of which are incorporated herein by reference.

The United States Government has rights in this invention pursuant to DOE-FOA-0000559, Energy Innovation Hub—Batteries and Energy Storage, and ANL Subcontract No. 3F-31144, issued under DOE Prime Contract No. DE-AC02-06CH11357 between the United States Government and UChicago Argonne, LLC representing Argonne National Laboratory.

### BACKGROUND OF THE INVENTION

This invention relates to flow batteries that maximize energetic efficiency utilizing non-Newtonian fluids.

The integration of renewable energy sources (e.g., wind and solar) and the efficient management of electricity on the existing grid stands to benefit from scalable, low-cost energy storage technology.¹⁻⁴ Several recent electrochemical energy storage approaches attempt to hybridize aspects of static and flowing batteries and thereby gain improvements in energy density and cost.⁵⁻⁷ Amongst these is the semi-solid flow cell (SSFC) of Duduta et al.,⁵ which integrates solid-state ion-insertion compounds in a mixed-conducting, flowable suspension. Instead of flowing an electronically insulating fluid through a porous current collector as in conventional flow batteries, the conductive suspension of the SSFC provides intrinsic electronic conductivity and can be flowed through unobstructed channels in the flow battery stack. By leveraging the high charge capacity of solid-state active materials and the high operating voltage of non-aqueous electrode couples, energy density can be increased dramatically over conventional aqueous flow batteries.⁵ Although suspensions typically have higher viscosity than solutions, for shear-thinning rheology it has been shown that flow-related losses can be <5% of stored electrochemical energy when the cell is operated in an intermittent flow mode, wherein fluid is replenished in discrete steps and electrochemically cycled when at rest.^{5,8,9} Subsequent studies adopting the semi-solid approach have integrated various electroactive solids in aqueous⁹ and non-aqueous^{10,11} electrolytes. The SSFC concept has also been extended to electrolytic flow capacitors.¹²⁻¹⁴

Even for redox couples that remain purely in solution form, a conductive suspension approach may offer advantages over the conventional flow architecture. The energy density of redox solutions increases in proportion to solubility (concentration), and large molecules tend to have higher solubility than small. Thus, increases in energy density are accompanied by higher viscosities that tend to inhibit flow through the conventional cells' porous current collectors.^{15,16} A suspension of percolating conductive particles (e.g., carbon black) in a redox solution can produce an electronically conductive redox electrode that can be used without a porous current collector.^{17,18} This intrinsic current collector network can also support precipitates formed upon cycling of low-solubility redox molecules (e.g., metal-coordinated couples¹⁹⁻²¹) and Li-polysulphides,^{7,22} and use of high surface area conductors such as carbon-blacks (˜1000 m²/g-carbon) may enhance charge transfer kinetics.

However, a viscous, conductive suspension may incur at least two efficiency loss mechanisms not encountered in conventional flow batteries. In addition to viscous dissipation, the electroactive region may extend outside the cell stack, leading to dissipation of electrochemical energy and thermal losses.²³ As we will demonstrate, the electrochemical performance is also coupled to the uniformity of the flow field; in general, non-uniformity leads to reduced coulombic and energetic efficiency.

### SUMMARY OF THE INVENTION

The flow battery according to the invention includes high energy density fluid electrodes having a selected non-Newtonian rheology and structure for providing intermittent flow pulses of controlled volume and duration of the fluid electrodes, the structure adapted to promote interfacial slip to improve flow uniformity.

In a preferred embodiment, the fluid electrodes are suspensions. The suspensions may contain active materials or conductive networks in redox solutions. It is preferred that the controlled volume be a critical aliquot for intermittent flow mode operation. Surface roughness, textures, or patterns may be selected to promote slip.

### BRIEF DESCRIPTION OF THE DRAWING

FIGS. 1a, b, c and d are schematic illustrations of the four part strategy to maximize efficiency constituted by flow volume control, suspension rheology, active-material thermodynamics, and interfacial slip promotion.

FIG. 2a is a perspective view of a simulated half-cell. Gray and black particles (not drawn to scale) respectively represent active materials and conductive additive that comprise a suspension.

FIG. 2b is a cross-sectional view of a two-dimensional domain employed in the present invention.

FIG. 3 is a schematic illustration of a two-aliquot intermittent flow cycle of LiFePO₄ suspension undergoing plug flow with unit aliquot factor m=1. Voltage, current arid flow-rate are shown as a function of time.

FIG. 4a is a graph of voltage against charge time for different active materials.

FIGS. 4b and c illustrate state-of-charge as a function of time for a two-aliquot plug-flow cycle with an aliquot factor of m=1.0.

FIG. 5a is a graph of voltage against charge time for three active materials.

FIG. 5b illustrates state-of-charge as a function of time for a two-aliquot cycle with Newtonian flow in the absence of slip and an aliquot factor of m=1.0.

FIG. 6a are graphs of voltage against charge time for three active materials.

FIG. 6b illustrates state-of-charge as a function of time for a two-aliquot cycle with Newtonian flow in the absence of slip and an aliquot factor of m=0.5.

FIG. 7a are graphs of voltage against charge time for three active materials.

FIG. 7b illustrates state-of-charge as a function of time for a four aliquot cycle with Newtonian flow in the absence of slip and an aliquot factor of m=0.5.

FIGS. 8a, b, c, d and e illustrate performance as a function of aliquot factor for a Newtonian flow without slip.

FIG. 9 is a graph of slip ratio versus yield radius forming a critical displacement profile map for the flow of a Bingham-plastic with wall slip.

FIGS. 10a, b, c, d and e illustrate performance as a function of slip number S1 with infinite mean velocity and with critical aliquots.

FIGS. 11a, b, c, d and e illustrate performance as a function of Bingham number Bn without wall slip and with critical aliquots.

### DESCRIPTION OF THE PREFERRED EMBODIMENT

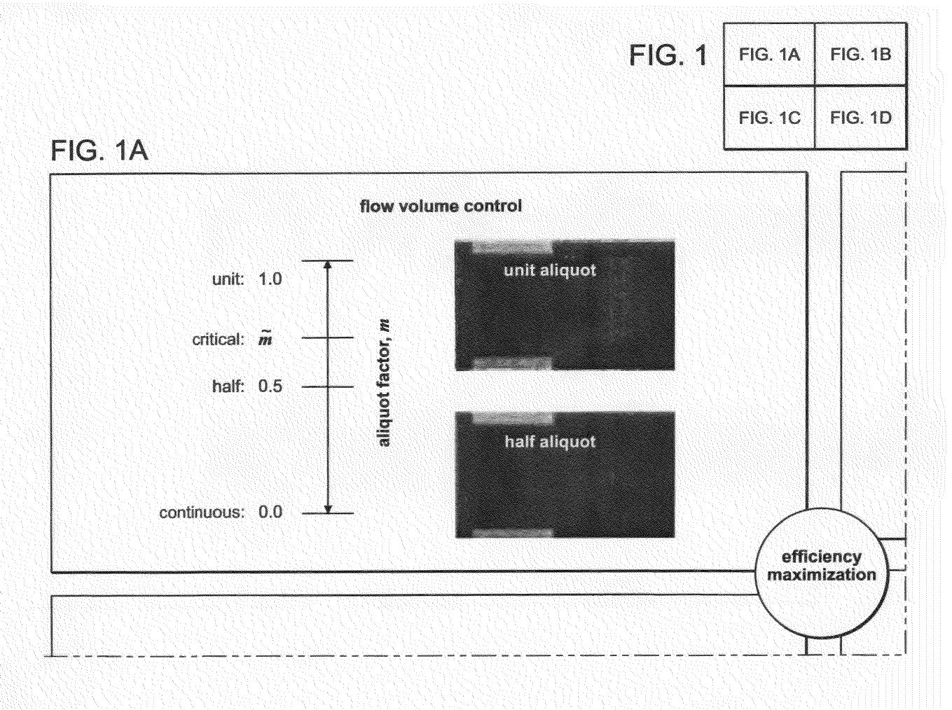

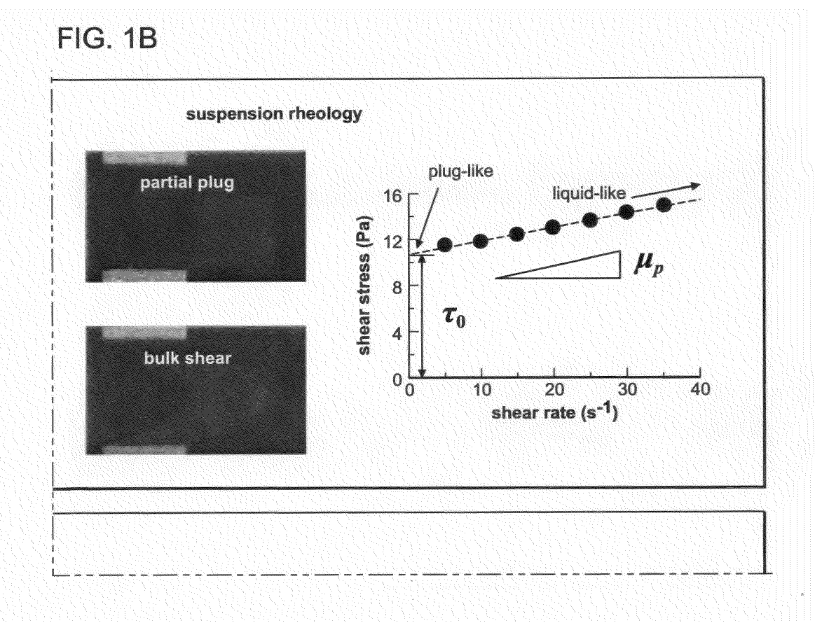

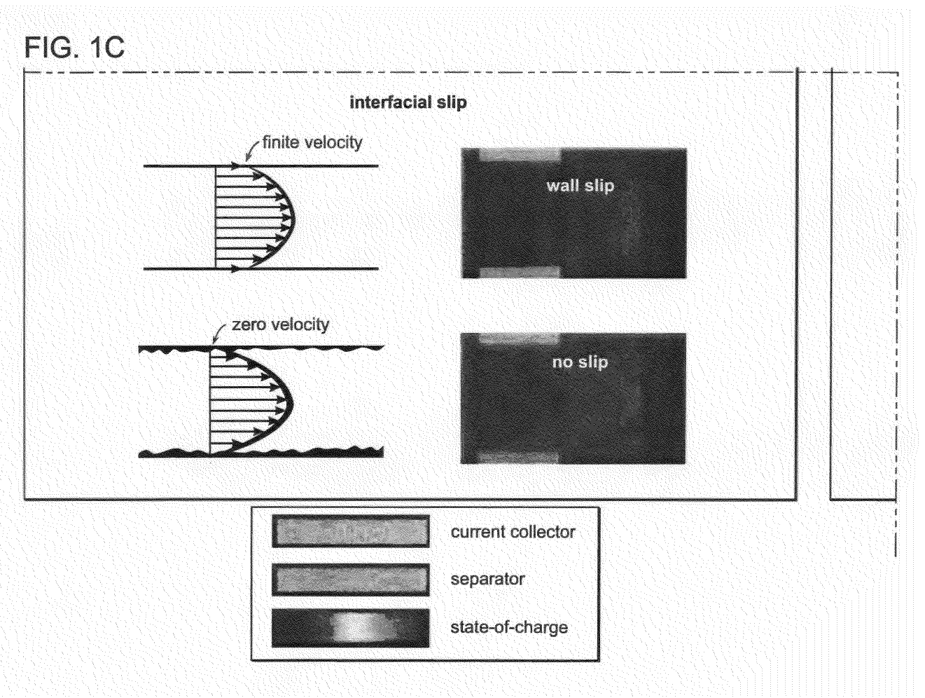

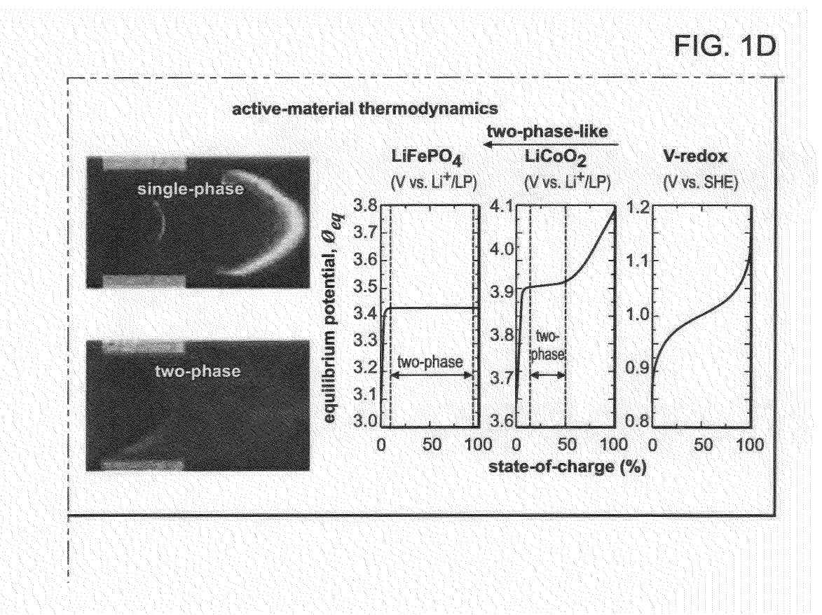

In this patent application, these loss mechanisms are simulated, and provide four strategies by which the energetic efficiency of suspension-based flow batteries can be maximized (FIG. 1). The components of this strategy are: (1) the control flow volume per pumping stroke, (2) promotion of slip at interfaces, (3) tailoring of suspension rheology, and (4) selection of active-material thermodynamics. A computational model of flowing electrochemistry is developed, generalized from previous work in which the model was tested against experimental results for one aqueous semi-solid electrochemical couple.⁹ We show that, while non-uniform flow velocities diminish capacity and efficiency, losses can be minimized through practical measures. Incorporation of all such optimizations suggest flow battery operation modes with up to 98% energetic efficiency exceeding that of conventional flow batteries,¹⁶ using readily achievable experimental parameters.

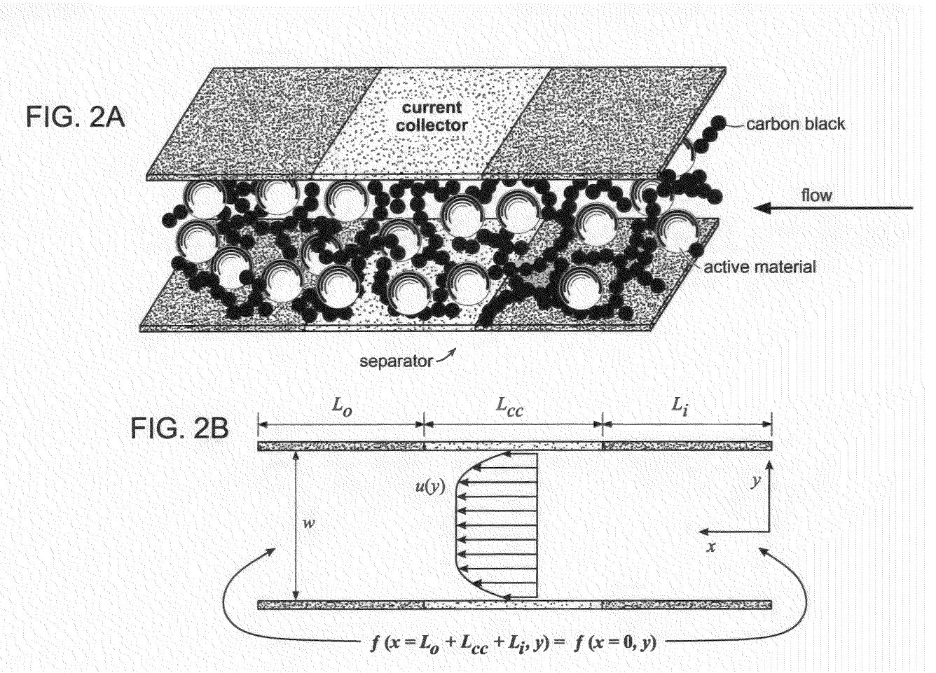

A schematic of the simulated flowing half-cell appears in FIG. 2(a). The electroactive region of the half-cell is the region between current collector (orange) and separator, the volume of which is referred to as a unit aliquot. Because semi-solid suspensions are mixed conductors, the electroactive zone,²³ in which electrochemical reactions occur, will extend outside the immediate electroactive region defined here. The separator (blue) facilitates the transfer of ions with an electrolyte bath at uniform, time-invariant potential. The suspension-based electrodes are assigned properties based on laboratory measurements of electrodes comprised of liquid electrolyte, carbon black, and active material. The two-dimensional geometry [FIG. 2(b)] is specified by the lengths of the inlet Lᵢ, current collector L_{cc}, and outlet Lₒ, as well as the width of the channel w. L_{cc} and w are fixed at 50 mm and 0.5 mm, respectively, while various values of Lᵢ and Lₒ are simulated depending on system size.

Three active materials (Table 1) were simulated.

TABLE 1
Suspension-based eletcrodes simulated. In each case, the active-material
loading corresponds to a capacity of 53.6 mA-hr/cm³ over the
specified voltage-cutoff window.

| active | active-material | | | | voltage-cutoff | |
|---|---|---|---|---|---|---|
| material | loading | | ionic potential, φ, | | window | |
| LiFePO₄ | 10.5 | vol % | 0.0 | V vs. Li⁺/Li⁰ | 3.0-3.6 | V vs. Li⁺/Li⁰ |
| LiCoO₂ | 8.2 | vol % | 0.0 | V vs. Li⁺/Li⁰ | 3.6-4.1 | V vs. Li⁺/Li⁰ |
| VO²⁺/VO₂⁺ | 2.0 | mol/L | −0.255 | V vs. SHE | 0.86-1.14 | V vs. SHE |

Two of these active materials are solid-state Li-ion intercalation compounds LiFePO₄ and LiCoO₂, and the other is a redox solution (VO²⁺/VO₂⁺). Each equilibrium potential versus state-of-charge (SOC) curve is illustrated in FIG. 1(d). For the redox system, the equilibrium potential increases monotonically with SOC. For the intercalation compounds, there is a range of SOC where the equilibrium potential has a plateau. These plateaus indicate equilibrium between two phases with states of charge given by the limiting plateau compositions. As discussed below, the plateau width (range of SOC) is an important feature in electrochemical performance, LiFePO₄ exhibits two-phase equilibrium between 9% and 97% SOC [FIG. 1(d)] which represents the majority of a practical electrochemical cycle:²⁴

LiFePO₄→LiₓFePO₄+(1−x)Li⁺+(1−x)e⁻.

A consequence of this two-phase equilibrium is that spatial SOC gradients can exist at thermodynamic equilibrium because LiFePO₄ particulates can have a particular phase fraction with any average SOC between 9% and 97% and maintain at the same equilibrium potential However, for LiCoO₂,^{25,26}

LiCoO₂→Li_{1-y}CoO₂+yLi⁺+ye⁻

the two phase plateau is much smaller. As a consequence, such equilibrium SOC gradients can exist over a smaller SOC window (15-50%). Thus, over most of a full SOC swing, LiCoO₂ exhibits single-phase behavior for which equilibrium gradients cannot exist. We model these solid-state active materials with non-aqueous electrolytes, e.g., 1 mol/L LiPF₆ in mixed carbonate solvent.²⁷

We also analyze the cathodic couple of the vanadium-redox aqueous solution (VO²⁺/VO₂⁺). The following simplified reaction is modeled in which VO²⁺ is oxidized to VO₂⁺ during charging:²⁵

VO²⁺+H₂O→VO₂⁺2H⁺+e⁻.

This system is hereafter referred to as “V-redox.” The solubility and mobility of redox ions in the electrolyte enables mixing of SOC throughout the cell. We modeled a suspension in which this redox solution contains a percolating network of electronically conductive particles. The resulting suspension has finite electronic conductivity as well as ionic conductivity, and charge transfer reactions are assumed to occur at the conductor-solution interface. Representative aqueous electrolytes for this system include H₂SO₄ (Ref. 28) and chloride solutions (Ref. 29).

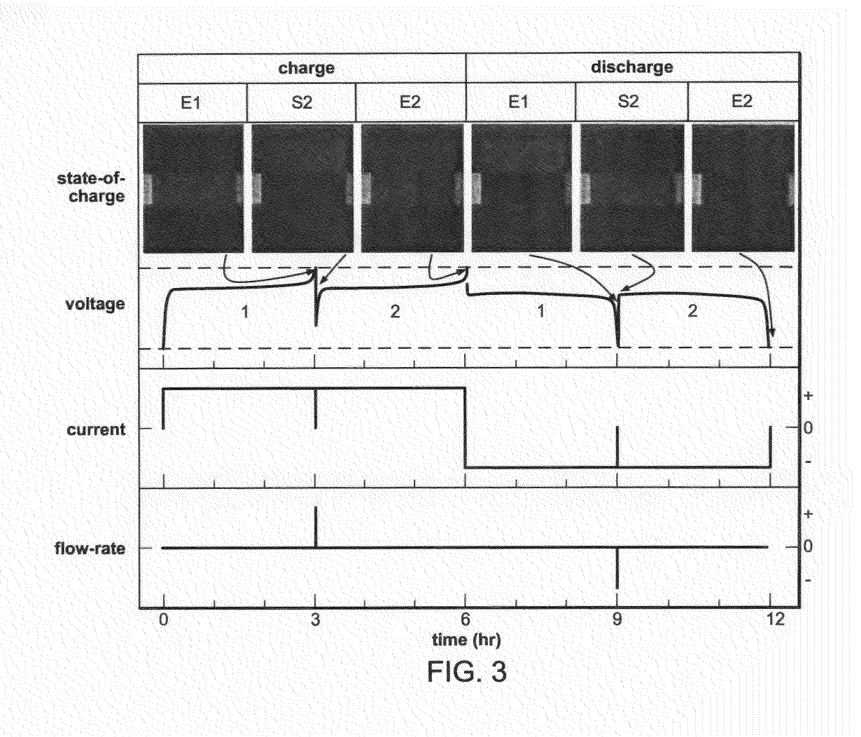

Previous work^{5,8} has demonstrated that operating SSFCs in an intermittent flow mode reduces pumping losses relative to the continuous flow mode in which conventional flow cells are typically operated. Accordingly, we emphasize the intermittent flow mode, although continuous flow behavior can be inferred directly by extrapolating to the limit of many short duration intermittent pulses. FIG. 3 depicts the evolution of SOC cell voltage for an intermittent cycle, defined by an alternating sequence of current and flow impulses. The particular process shown involves the cycling of only two aliquots, which is the shortest complete cycle possible. As we will show, this two-aliquot cycle sets an upper bound on efficiency losses. The cycling of more aliquots demonstrates convergence to a fixed capacity and efficiency.

An alphanumeric rubric is used to distinguish the cycle steps for all of the subsequent results, as shown in FIG. 3. The first charging step starts from a fully discharged state (charge-S1, not shown) and ends when the terminal charging voltage is reached (charge-E1). Subsequently, suspension is flowed through the cell in the absence of current to eject charged material from the electroactive region. The second charging step starts (charge-S2) and ends after the terminal charging voltage is reached (charge-E2). In steps S1-E2, two aliquots of fluid are charged. To discharge, the current and flow direction are reversed and commences with discharge-S1 (not shown). When this discharge step reaches the limiting voltage (discharge-E1), flow is also reversed to replenish the electroactive region with charged suspension, and the second discharge step starts (discharge-S2). The cycle is completed after the terminal discharge voltage is again reaches (discharge-E2).

The cycle above represents the simplest in a class of intermittent cycles for which we now describe the possible operational parameters. We define the pumped volume relative to that of a unit aliquot (i.e., the cell's internal volume) and refer to this quantity as the aliquot factor m, (e.g., m=1 and m=0.25 correspond to pumping one full aliquot and one-quarter aliquot per pump stroke, respectively.) The system's total suspension volume is given as a multiple of unit aliquots. The flow rate at which pumping occurs dictates the flow profile shape for a particular suspension rheology, suspension/wall interface, and cell channel design. As we show below, the influence of flow rate, material parameters (both rheological and slip), and channel dimensions can be captured in terms of two dimensionless parameters describing the complete space of velocity profiles for a typical non-Newtonian flow electrode exhibiting both wall slip and steady shear in the suspension's bulk.

The electrochemical operation of the cell is specified by the upper and lower voltage cutoff limits applicable to the electrochemical couple (Table 1) and the time dependence of the applied current, I_{applied}. One of the attributes of flow batteries is that the relative capacities of the stack and tanks can be varied arbitrarily. Here we stimulated current rates for the cell of C/3 (full charge and discharge of the stack in 3 hours), corresponding to long-duration storage for a complete system that is some multiple of 3 hours.

The computational model includes simultaneous electrochemical processes (electronic conduction, reaction kinetics, and redox-species diffusion) and fluid flow. The symmetry of the simulated cell allows it to be modeled as two-dimensional [FIG. 26]. Solution-phase polarization resulting from ion conduction in the electrolyte is neglected. For suspensions containing representative electrolytes this assumption is valid, because (1) electronic conductivity (˜1 mS/cm) dominates polarization, being at least ten-fold less than ionic conductivity and (2) the time-scale for salt depletion through the electrode thickness exceeds the cycling time by more than ten-fold (see conductivities and diffusivities in Refs. 27,30). Fluid pulses in the intermittent operation mode are assumed to occur infinitely fast, enabling the isolation of electrochemical cycles into two distinct states governed by either (1) electrochemistry without flow or (2) flow without electrochemistry. These processes are described in detail below, as well as the boundary conditions imposed and the numerical discretization techniques implemented.

In the absence of flow, electronic conduction occurs via the conductive-particle percolating-network suspended in the electrolyte, and the solid-phase potential φₓ is governed by charge conservation:

∇·(−σₛ∇φₛ)+aiₙ=0, (1)

where φₛ is the effective electronic conductivity of the suspension. The second term in Eq. (1) is a source term that couples electronic conduction to the electrochemical surface reaction characterized by the local reaction current density iₙ and surface area per unit suspension volume a. Because the entire suspension is electronically conductive, electrochemical reactions can occur outside the immediate electroactive region of the cell ²³ (this is implicit in Eq. 1). It has been shown that the electronic conductivity varies widely with carbon black content.^{5,9,31} Here, we assume a value of 1 mS/cm for σₛ corresponding to experimental results for −1 vol. % Ketjen black in non-aqueous³¹ and aqueous⁹ suspensions. Recent work has also shown that the electronic conductivity of semi-solid suspensions depends on shear rate,³² but such variations will have negligible impact on the intermittent flow mode used here (i.e., charging takes place when the semi-solid electrode is static). In addition, conductivity variations due to microstructural relaxation after a flow pulse are expected to be minimal, since oil-based suspensions of carbon black have exhibited gelation times³³ that are at least five orders of magnitude smaller than the present charge/discharge time-scales.

For suspensions using typical Li-ion intercalation compounds (e.g., LiFePO₄ and LiCoO₂) of fine particle size, intercalated lithium concentration at the particle surface differs by less than 1% of the bulk value at C/3 rate (based on room-temperature diffusivities inferred from Refs. 34,35). Consequently, the intercalated lithium fraction x_{Li} at a given time t is assumed uniform and is governed by the following conservation equation:

$${v}_{s} {c}_{s , max} \frac{\partial {x}_{Li}}{\partial t} + a \frac{{i}_{n}}{F} = 0 , \qquad ( 2 )$$

where c_{s,max} is the volumetric concentration of intercalated lithium at saturation, vₛ is the volume fraction of active material, and F is Faraday's constant. The values of c_{s,max} for LiFePO₄ and LiCoO₂ are 22.8 mol/L (Ref. 36) and 51.6 mol/L (Ref. 37), respectively. (It is these high molarities, compared to the 1-2 mol/L concentrations typical of aqueous redox flow batteries,^{15,16} that allow semi-solid electrodes to have high energy densities.) SOC is defined by the intercalated lithium fraction relative to those at the charge and discharge cutoff voltages listed in Table 1.

In the case of the V-redox system, the diffusion time-scale for redox molecules through the electrode thickness is much shorter (˜10 s) than the cycling time-scale. The flux of redox species is dominated by diffusion (i.e., not migration), because the high ionic conductivity of concentrated, acidic electrolytes (e.g., H₂SO₄ (Ref. 28) or chloride solutions²⁹) minimizes the electric field that drives migration. Therefore, mass conservation of VO²⁺ and VO₂⁺ in the absence of migration sufficiently describes the electrochemical processes that occur in the V-redox system:

$$\begin{matrix}ɛ \frac{\partial {c}_{{VO}_{2}^{+}}}{\partial t} + ɛ ∇ \cdot ( - {D}_{eff , {VO}_{2}^{+}} {∇}_{{C}_{{VO}_{2}^{+}}} ) - a \frac{{i}_{n}}{F} = 0 , & ( 3 ) \\ ɛ \frac{\partial {c}_{{VO}^{2 +}}}{\partial t} + ɛ ∇ \cdot ( - {D}_{eff , {VO}^{2 +}} {∇}_{{C}_{{VO}^{2 *}}} ) + a \frac{{i}_{n}}{F} = 0 , & ( 4 )\end{matrix}$$

where cⱼ and D_{effj} are the concentration and effective diffusivity of redox species j in the electrolyte. The SOC of the electrode is equivalent to the concentration of VO²⁺. Source terms in Eqs. 3 and 4 couple redox-species diffusion to the electrochemical reaction that occurs at conductor-electrolyte interfaces. The exclusion of electrolyte volume from the suspension by the conductive carbon (1 vol. % loading) is negligible, and the suspension's porosity ε is approximately 100%. The diffusivities for both V-redox species are assigned bulk values of 3.9×10⁻⁰¹ m²/s from literature.³⁸

The surface overpotential η drives electrochemical reactions at solid-electrolyte interfaces and is given as η=φₛ−φₑ−φ_{eq}, where φₑ and φ_{eq} are the ionic potential of the electrolyte and the equilibrium potential of the active material, respectively. The equilibrium potential models of the three active materials (as a function of x_{Li} and redox species concentrations) were taken from the literature³⁹⁻⁴¹ and are shown in FIG. 1(d) with respect to SOC. The ionic potential φ₀ is assumed uniform at the value of the chosen counter-electrode (Table 1). A Butler-Volmer model describes the surface reactions for all three suspensions. Assuming equal anodic and cathodic transfer coefficients, the reaction current density iₙ is:³⁰

$${i}_{n} = {i}_{0} [ exp ( \frac{0.5 F η}{RT} ) - exp ( - \frac{0.5 F η}{RT} ) ] , \qquad ( 5 )$$

where i₀ is the exchange current density and RT has its usual meaning. In general, the exchange current density i₀ depends on the concentration of active species. This dependence reflects the competition between forward and reverse reactions at the conductor-electrolyte interface, and, therefore, the functional form of i₀ depends on the type of reaction. Table 2 summarizes the kinetic parameters and volumetric surface area, a (m²/m³), for each suspension. For the solid-state active materials, a is the active-particle/electrolyte interface area (per unit suspension volume), and the exchange current density can be expressed as:⁴²

i₀=Fkc_{s,max}(cₑ)^{0.5}(1−x_{Li})^{0.5}(x_{Li})^{0.5}, (6)

where cₑ is the ion-conducting species concentration in the electrolyte (taken as 1 mol/L here), k is the reaction rate-constant, and x_{Li} is the intercalated lithium fraction (determined by solving Eq. 2). The values of a used here assume 100 nm diameter LiFePO₄⁴³ and 4 μm diameter LiCoO₂³⁷ particles.

TABLE 2
Kinetic parameters of simulated suspensions.

| active | | | | Volumetric surface |
|---|---|---|---|---|
| material | rate constant, k | | Ref. | area, a (m²/m³) |
| LiFePO₄ | 3.0 × 10⁻¹³ | m/s/(mol/m³)^{0.5} | [31] | 6.3 × 10⁶ |
| LiCoO₂ | 2.3 × 10⁻¹¹ | m/s/(mol/m³)^{0.5} | [32] | 1.2 × 10⁵ |
| VO²⁺/VO₂⁺ | 3.0 × 10⁻⁹ | m/s | [34] | 3.2 × 10⁷ |

The exchange current density i₀ for the cathodic V-redox reaction depends on the concentration of redox species j at the reaction surface, cⱼ^{s}:²⁸

i₀=Fk(c_{VO}_{₂}_{⁺}^{s})^{0.5}(c_{VO}_{²⁺}^{s})^{0.5}. (7)

Pore-scale mass-transfer resistance causes surface concentrations, cⱼ^{s}, to differ from the bulk electrolyte concentrations, cⱼ, of a given species j:²⁸

$$\begin{matrix}{c}_{{VO}_{2}^{+}} - {c}_{{VO}_{2}^{+}} = \frac{{i}_{n}}{F} \frac{{d}_{p}}{{D}_{{VO}_{2}^{+}}} , & ( 8 ) \\ {c}_{{VO}^{2 +}} - {c}_{{VO}^{2 +}}^{s} = \frac{{i}_{n}}{F} \frac{{d}_{p}}{{D}_{{VO}^{2 +}}} , & ( 9 )\end{matrix}$$

where dₚ is the pore diameter of the material on which the surface reaction takes place. We utilize the procedure described in Ref. 28 to determine the surface concentrations, for the V-redox suspension 1 vol. % loading of Ketjen black is assumed with a specific surface area of 1453 m²/g (Ref. 44) and a pore diameter of 100 nm (in between the size of the carbon black aggregates and the individual particles comprising them⁴⁵).

When intermittent flow pulses occur much faster than electrochemical processes, pure advection governs both intercalated lithium fraction:

$$\frac{\partial {x}_{Li}}{\partial t} + \vec{v} \cdot ∇ {x}_{Li} = 0 , \qquad ( 10 )$$

and species concentration fields:

$$\frac{\partial {c}_{j}}{\partial t} + \vec{v} \cdot ∇ {c}_{j} = 0 , \qquad ( 11 )$$

where \vec{v} is the suspension velocity field. Fully developed, axial flows are considered here, the velocity fields of which are non-zero only in the x-direction and depend only on the y-coordinate [see FIG. 2(b)]:

\vec{v}=u(y)î, (12)

where î is the unit vector along the channel's axis (taken as the x-coordinate). Results for a variety of velocity profiles are presented below.

To simulate galvanostatic charge/discharge conditions a time-invariant total current I_{applied} is imposed at current-collector/suspension boundaries (denoted, Γ_{cc}):

$${I}_{applied} = {\int }_{{Γ}_{∝}} - {σ}_{s} ∇ {φ}_{s} \cdot d \vec{Γ} , \qquad ( 13 )$$

where d\vec{Γ} is the inward-pointing differential area vector. The present simulations use an applied current concomitant with the complete charging of the electroactive region in 3 hours (i.e., C/3 stack-level rate). Potential drops due to bulk resistance of the metallic current collector are neglected. Contact resistance at the suspension/current-collector interface is also neglected, as its value is highly material-dependent. We note that contact resistance would increase the effective impedance of the cell and is not expected to change the qualitative trends observed here. Though flow-induced contact resistance in electrochemical flow capacitors has been suggested,¹⁴ their effect in the intermittent flow mode will be minimal because all charge transfer takes place when the electrode is static. All remaining surfaces in contact with the suspension are modeled as electronically insulating.

For the V-redox system, a proton-conducting membrane impenetrable to redox species is assumed in place of the separator in FIG. 2(a). Zero-flux conditions for the redox species are imposed at each of these separator surfaces. At the inlet and outlet of the simulated cell, periodic boundary conditions are imposed on each solved parameter [FIG. 2(b)].

The governing equations for electrochemistry without flow were discretized with the finite volume method⁴⁶ with implicit discretization in time and central difference discretization in space. The fully coupled set of electrochemical equations was solved with the aggregation-based algebraic multigrid program.⁴⁷⁻⁵⁰ Iterative convergence of all overpotentials was achieved within 10⁻⁹ V. Because the transfer of charge and species is purely advective during intermittent pumping, a semi-Lagrangian method was implemented to obtain solutions to Eqs. 10 and 11. Specifically, intercalated-lithium fraction and species concentration were determined using backward-time, nearest-neighbor interpolation along streamlines. The resulting numerical scheme conserves species, because the streamlines (along which nearest-neighbor interpolation is performed) are horizontal and parallel to the flow field's streamwise x-coordinate. The scheme lacks the artificial numerical diffusion that plagues upwind differencing schemes.⁴⁶ The lack of numerical diffusion of the present scheme enables accurate solutions even for coarse meshes in the streamwise direction along the cell's axis (i.e., the x-direction). Therefore, the computational domain was discretized with an anisotropic, rectilinear mesh having cells of length 0.500 mm and 0.010 mm in the x (streamwise) and y (transverse) directions, respectively. A time step of 8.6 s was used to march the solution forward in time, adapted as necessary to ensure convergence of the iterative solver.

First, the temporal variation of voltage and SOC during the cycling of two aliquots of suspension is shown for three flow scenarios to elucidate efficiency-loss mechanisms: (1) plug flow of a unit aliquot (m=1), (2) Newtonian flow of a unit aliquot (m=1) in the absence of slip, and (3) Newtonian flow of a half-aliquot (m=0.5) in the absence of slip. Effects of increasing total flow-volume are also simulated. Subsequently, optimization with respect to aliquot factor is addressed for fixed flow profiles. Finally, performance for flows having various degrees of slip and bulk shear is assessed for optimized aliquot factors.

The following five metrics are used to quantify electrochemical performance:
Charge capacity (%)—the ratio of stored charge to the theoretical maximum,
Coulombic efficiency (%)—the ratio of discharge capacity to charge capacity,
Average polarization (mV)—half the difference between the time-averaged cell voltage during charge and discharge respectively,
Discharge energy (%)—the ratio of delivered energy to the theoretical maximum, and
Energetic efficiency (%)—the ratio of discharge energy to charge energy.

When an aliquot of charged suspension is pumped out of the electroactive region of the flow cell, ideal plug flow, defined as uniform translation of charged material, is not typically observed. Instead, the shear-thinning rheology of semi-solids^{5,31} results in bulk shear, which in turn distorts SOC and concentration fields upon advection.

To illustrate this effect, we compare ideal plug flow to ideal Newtonian flow without wall slip. Plug flow is a reasonable lower bound to the extent of flow non-uniformity because it can be induced in attracting colloidal suspensions by the formation of lubricating liquid layers at walls upon shear.⁵¹ And, shear-thinning fluids adopt some degree of plug flow even without wall slip. However, the other extreme is pure Newtonian flow without slip, which results in greater non-uniformity (quantified as the ratio of the centerline velocity to the mean velocity) than is seen for shear-thinning fluids (e.g., Bingham plastics, power-law fluids,⁵² and Cassonian fluids⁵³). Therefore, Newtonian flow without slip is a reasonable upper bound representing maximum non-uniformity of flow.

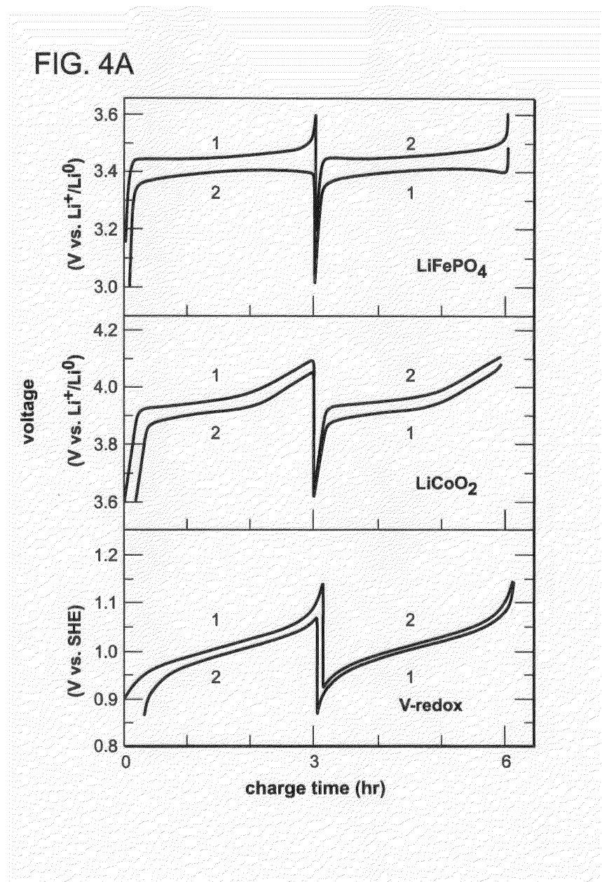

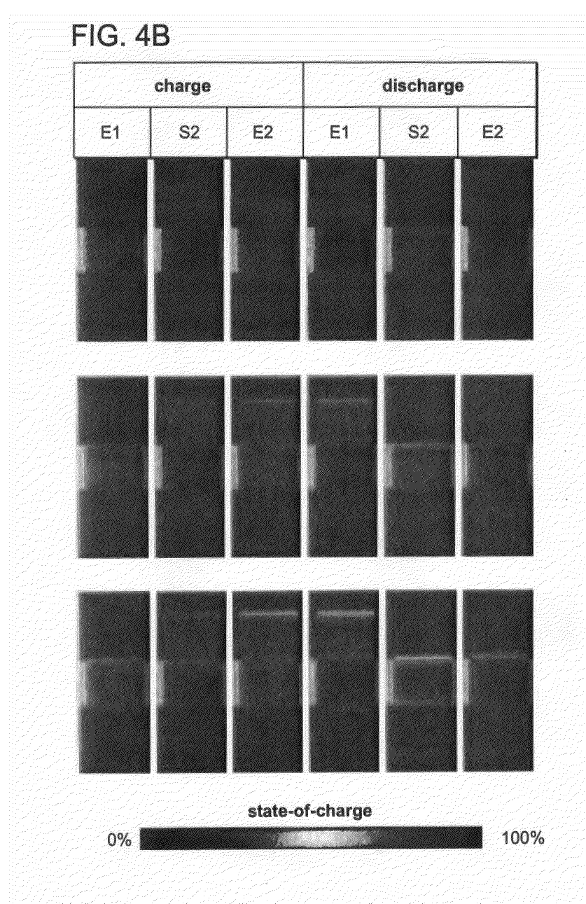

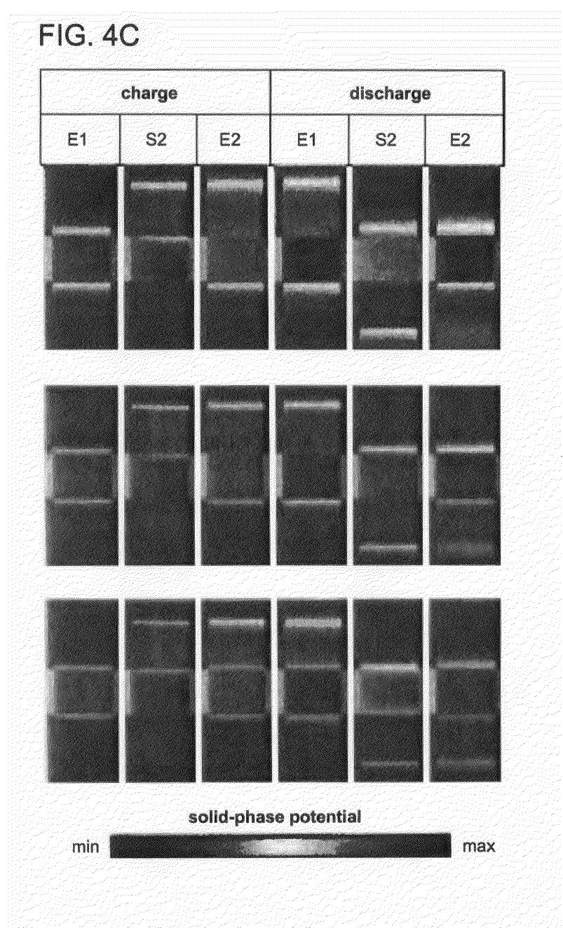

Consider first the plug flow of two sequential aliquots each having unity aliquot factor (m=1). Shown in FIG. 4(a) is the cell voltage variation with charge time (i.e., the discharge process proceeds in decreasing time) for each of the suspensions simulated. As shown in Table 3, each of the suspensions exhibits near-theoretical charge capacity, but the coulombic efficiency does increase in the order of V-redox to LiCoO₂ to LiFePO₄. This ordering corresponds to increasing SOC-range of two-phase stability [see FIG. 1(d)]. Coulombic efficiency loss occurs as the electroactive zone (in which electrochemical reactions take place) extends beyond the immediate electroactive region (over which the current collector extends). This phenomenon is particular to suspension-based flow batteries, where the working fluid is a mixed conductor.²³

TABLE 3
Cycling conditions, charge capacity, and coulombic efficiency for the cases presented
in FIGS. 4-7.

| cycling conditions | | | | | | | | |
|---|---|---|---|---|---|---|---|---|
| | | no. | | | | | | |
| allquot | flow | aliquots | charge capacity (%) | | | coulombic efficiency (%) | | |
| factor, m | profile | cycled | LiFePO₄ | LiCoO₂ | V-redox | LiFePO₄ | LiCoO₂ | V-redox |
| 1 | plug | 2.0 | 100 | 99 | 102 | 99 | 97 | 96 |
| 1 | Newtonian | 2.0 | 91 | 90 | 94 | 96 | 80 | 80 |
| | (no slip) | | | | | | | |
| 0.5 | Newtonian | 2.0 | 100 | 99 | 102 | 96 | 89 | 89 |
| | (no slip) | | | | | | | |
| 0.5 | Newtonian | 4.0 | 87 | 92 | 94 | 98 | 95 | 95 |
| | (no slip) | | | | | | | |

The SOC field [FIG. 4(b)] and potential field of the electron-conducting phase [FIG. 4(c)] show evidence of such electroactive zone extension. These fields are shown at the start (S) and end (E) of charge and discharge steps, and in all figures they are elongated in the transverse direction to aid visualization. The edge of the electroactive region has diffuse SOC bands [FIG. 4(b)], because continuity of the electron-conducting phase drives its potential beyond the electroactive region [FIG. 4(c)]. This potential induces reactions outside the cell's electroactive region. At the edges between charged and discharged suspensions, the diffuse SOC bands grow with time and are most readily seen for the V-redox system. This dissipated charge is not recovered during subsequent cycling (see discharge, S2) and accounts for the majority of coulombic inefficiency. In the case of LiFePO₄, diffuse SOC bands are not visible in FIG. 4(b), but the potential front propagates well beyond the immediate electroactive region [FIG. 4(c) and Video S1]. Coulombic loss is suppressed for LiFePO₄, because low SOC (9%) suspension outside the electroactive region can coexist at equilibrium with suspension at dissimilar SOC in the electroactive region (9-97%). Such suppression of charge transfer occurs to a lesser extent for LiCoO₂, because it has a smaller two-phase SOC range (15-50%).

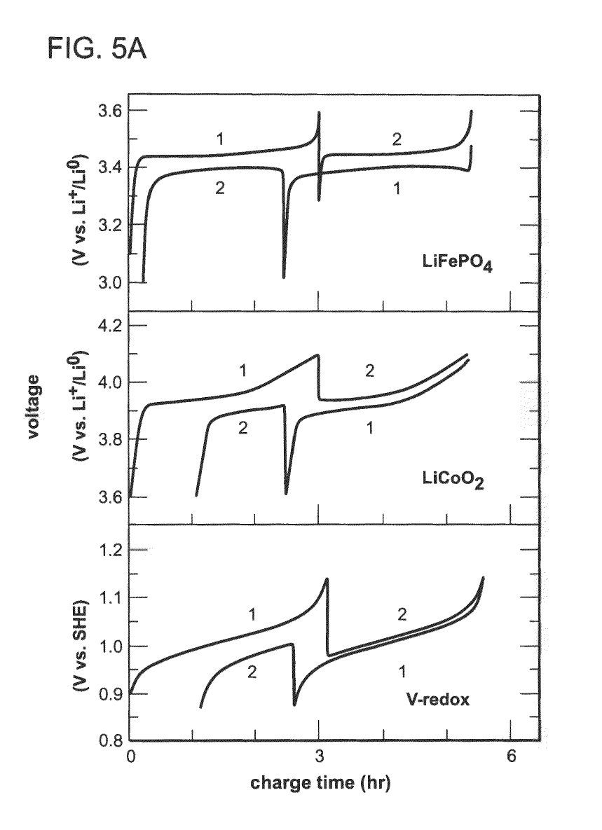

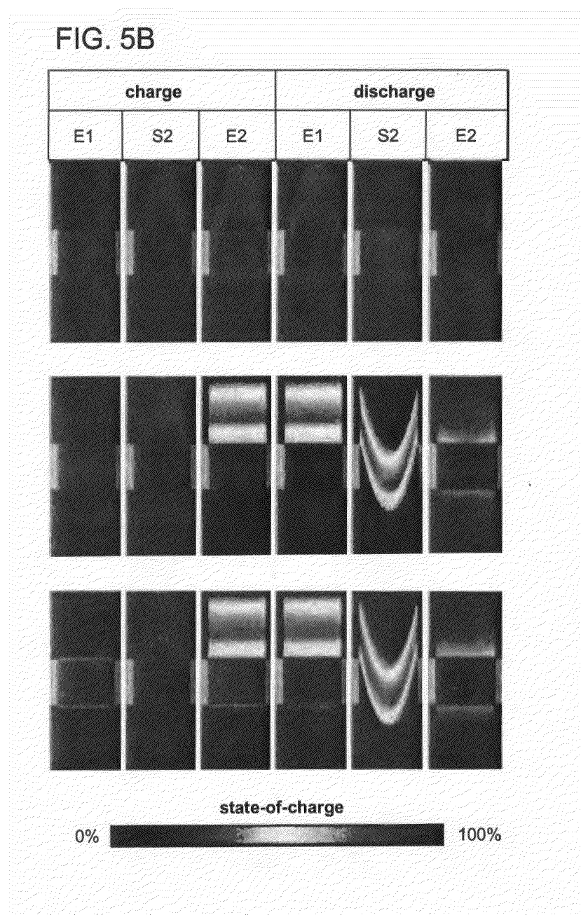

Newtonian flow without slip was simulated for the same cycle. The impact of the greater flow non-uniformity on the cell voltage [FIG. 5(a)] is dramatic. Charge capacity and coulombic efficiency are reduced well below the values seen for the corresponding plug-flow cycle (Table 3). The cause of this behavior is illustrated by the SOC after the first intermittent pumping step (charge S2). The lack of slip at the wall leaves residual charged material that remains behind upon subsequent pumping. As a result, the second charge step has lower capacity than the first for all suspensions.

FIG. 5(a) and Table 3 show that under Newtonian flow without slip coulombic efficiency is sensitive to the voltage-capacity relationship for the active material. LiFePO₄ with its wider two-phase coexistence (flat voltage-capacity curve) is much more efficient (96%) than the two other suspensions (80%) which have small (LiCoO₂) or no (V-redox) equilibrium voltage plateaus. This inefficiency results from the transfer of charge outside of the electroactive region after flow. SOC snapshots at the start and end of the second charge (charge, S2 and E2) show this effect most clearly. At the start of the second charging step, SOC gradients induced by non-uniform flow are apparent, but with sufficient time, charge transfer outside of the electroactive region induces equilibration with discharged suspension transverse to the flow direction (charge, E2). The effect is most visible for LiCoO₂ and V-redox suspensions, again because their reactions occur primarily as single-phase transformations. In concert, these processes lengthen suspension aliquots and reduce the SOC inside the aliquot. This process wherein chemical diffusion is apparently enhanced by shear is referred to as dispersion.⁵⁴ On the final discharge step [discharge, E2, in FIG. 5(b)], the dispersive effect is most obvious. The loss of coherency of the displaced aliquot results in an abundance of incompletely charged material outside of the electroactive region of the cell. In contrast, two-phase LiFePO₄ aliquots remain largely intact during cycling, and nearly all charge is extracted from that suspension.

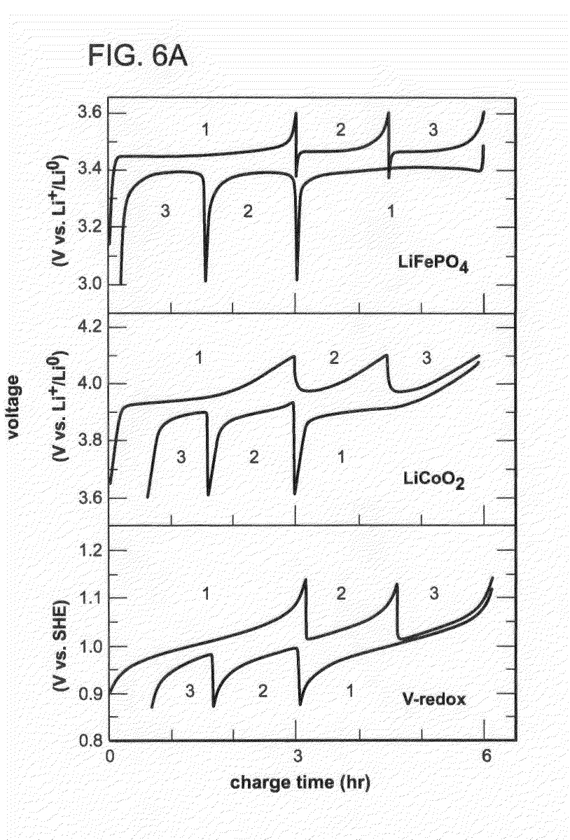

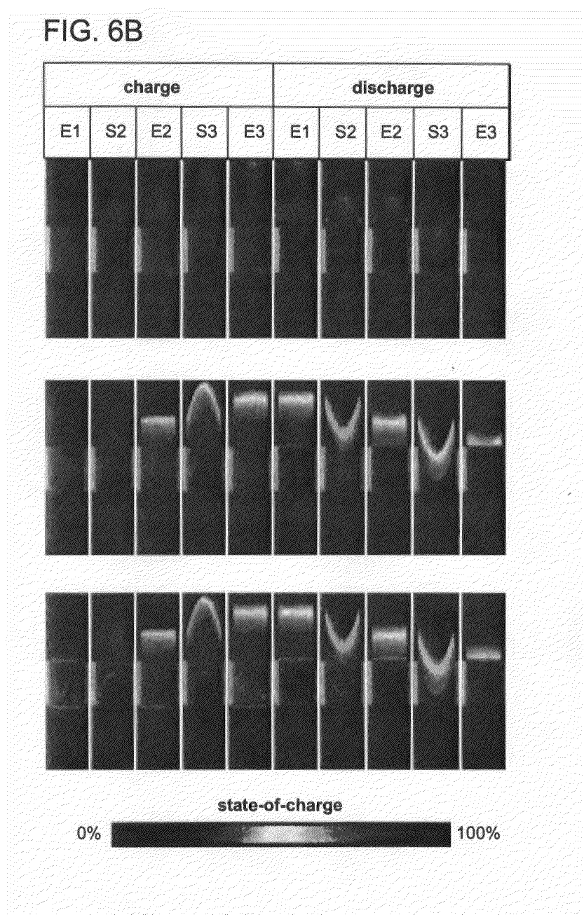

The previous result demonstrates that non-uniform flow leads to inefficient electrochemical cycling. Though plug flow is ideal, in practice it is not realizable for all suspensions. Thus, in many situations this non-ideal behavior may need to be managed so as to minimize inefficiencies. One strategy is to pump suspension aliquots of lesser volume (i.e., m<1), in a pseudo-continuous mode. The effect of such m<1 aliquot cycles is illustrated in FIG. 6, where flow is again Newtonian without wall slip, and the cycle is identical to the previous one except for pumping half-aliquots (m=0.5). Both charge capacity and coulombic efficiency are improved relative to the m=1 cycle (Table 3). In fact, the charge capacity is now the same as for plug flow at m=1, with the flow profiles showing that this results from preventing suspension from passing through the electroactive region uncharged. This is seen by comparing the SOC distributions at the start of the second charge step for m=1 and m=0.5 [cf., charge S2 in FIGS. 5(b) and 6(b)]. However, the coulombic efficiency for m=0.5 Newtonian flow without slip remains less than for plug flow at m=1 (Table 3), due to persisting charge dispersion outside of the electroactive region, manifested as residual SOC after the last discharge step [discharge E3, FIG. 6(b)].

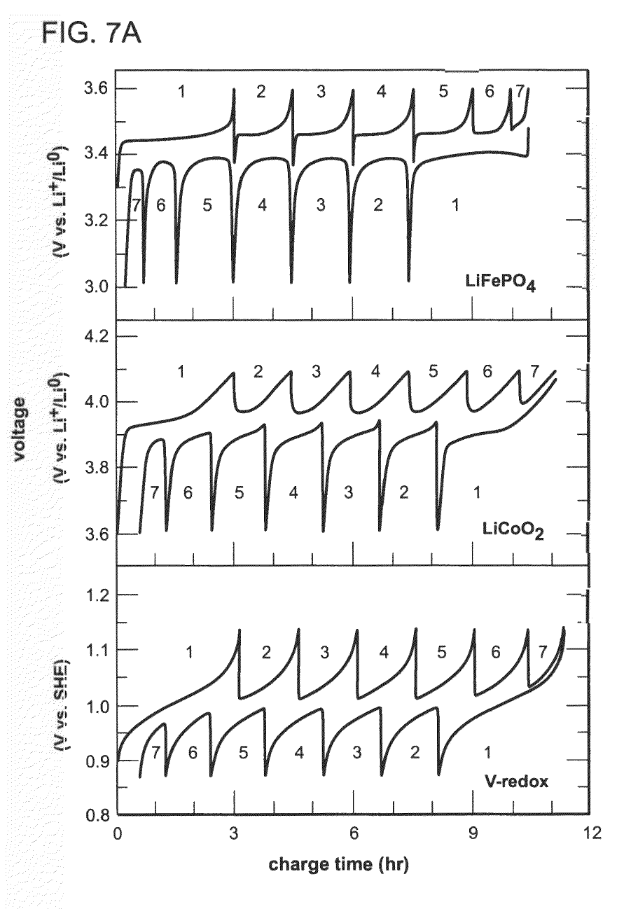

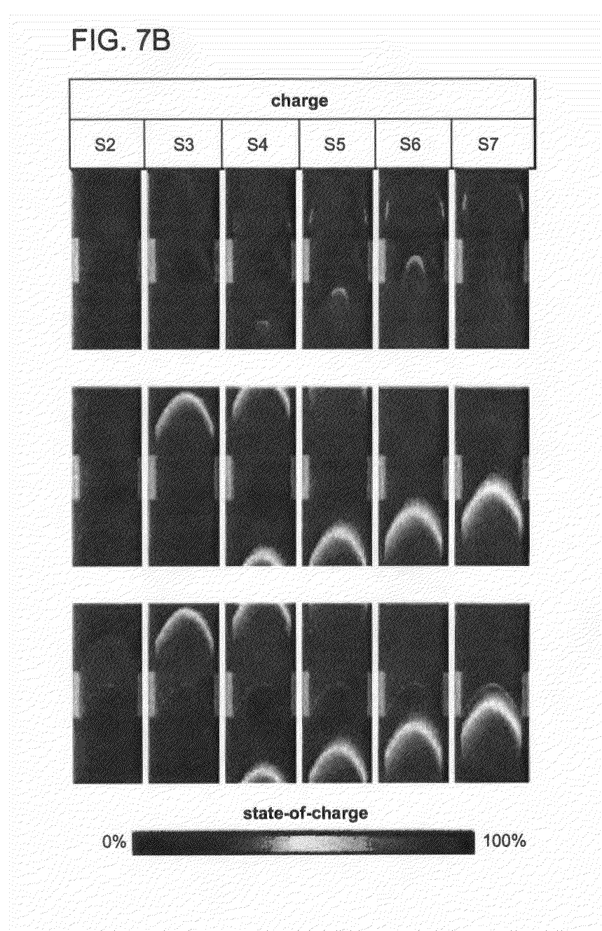

The three cases considered so far have cycled one-half of the total system volume (2 aliquots out of 4 total). As more cycles are added, we find an interesting result where the capacity is further reduced due to a different mechanism than already described, but the round-trip coulumbic efficiency improves. This is seen in the last two rows of Table 3, which compare m=0.5 Newtonian flow results for pumping 2 aliquots versus 4. Suspension near the centerline that was charged on the first step protrudes into the electroactive region during later charge steps [FIG. 7(b), charge S7], limiting charge capacity, even as coulumbic efficiency improves. When system size is increased further to 7 aliquots and the system is cycled completely, the capacity is within 2% and the coulombic efficiency is within 0.5% of that in the 4-aliquot system. This suggests that the capacity and coulumbic efficiency of large systems operated under equivalent stack-level conditions (flow profile, flow volume, and charge/discharge rate) converge to limiting values near those for the 4-aliquot system shown here.

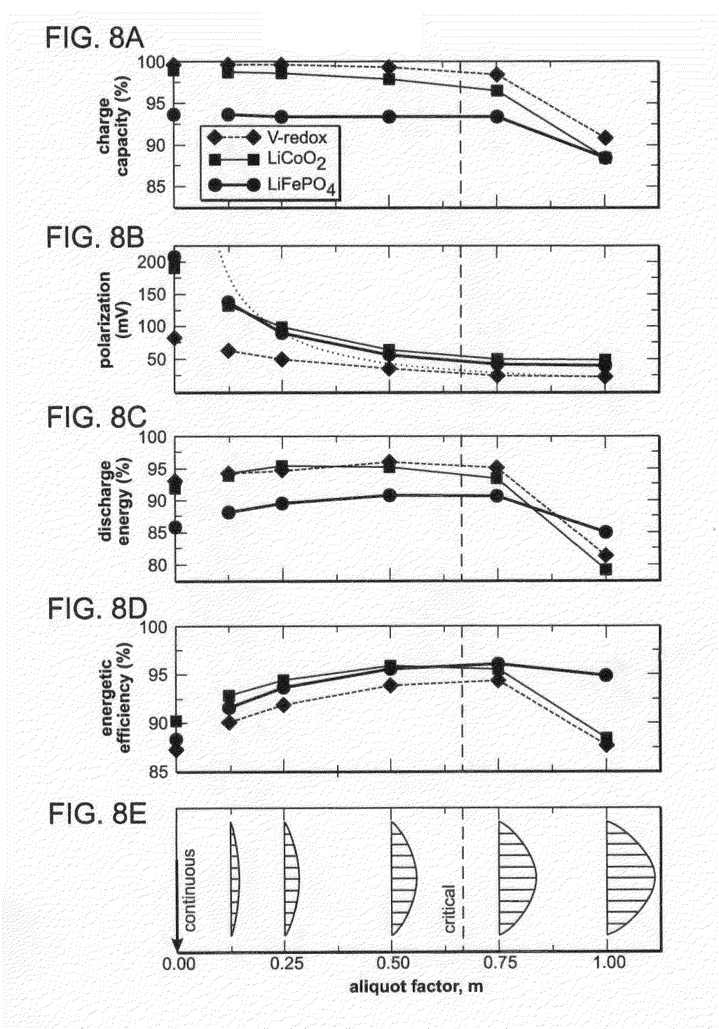

The preceding results illustrate that flow velocity profiles, displaced aliquot size, and active-material phase equilibria all influence charge capacity and coulombic efficiency. Extending the comparison of m=0.5 and m=1.0, we now test the conjecture that an optimum aliquot factor must exist, at which the total discharge energy and energetic efficiency are maximized. The electrochemical performance for aliquot factors from m=0.125 to m=1 are shown in FIG. 8. The calculated suspension displacement profiles are shown in FIG. 8(e). A 4-aliquot system was modeled. In addition, half of the system's suspension was cycled twice during both charge and discharge, limiting coulombic efficiency losses of the m=0.5 case, for example, to less than 1% versus as much as 5% coulombic efficiency loss with normal cycling.

A critical aliquot factor \tilde{m} can be defined that corresponds to the geometric condition where the upstream edge of the displaced aliquot is tangent to the downstream edge (i.e., outlet) of the electroactive region. When this condition is met, the critical aliquot factor can be calculated via streamline integration for laminar flows. For steady (i.e., time-invariant) flow that is one-dimensional, fully developed, and incompressible, the critical aliquot factor is:

\tilde{m}=ū/uₘₐₓ, (14)

where ū and uₘₐₓ are the mean and maximum axial velocities of the flow. For the no-slip Newtonian case, \tilde{m}=2/3. For Newtonian flow without slip, FIG. 8(a) shows that charge capacity drops sharply above this critical aliquot factor, because discharged suspension is pumped past the electroactive region if m>\tilde{m} [as illustrated in FIG. 5(b)]. Below this critical aliquot factor, the charge capacity [FIG. 8(a)] is weakly dependent on the aliquot factor.

FIG. 8(b) shows that the cell polarization decreases monotonically with increasing aliquot factor. This scaling is primarily due to the constriction of current when the electroactive region is not completely replenished. Residue left behind from prior cycle steps results in a heterogeneous distribution of SOC within the electroactive region. Consequently, current becomes localized on region of the current collector nearest fresh suspension. Due to this localization of current, heightened ohmic drop occurs across the section of fresh suspension, manifesting as polarization at the cell level. This interpretation is supported by the good agreement between the calculated polarization and that predicted by a simplified model of current localization [red-dotted line, FIG. 8(b)]. In this simplified model current is distributed uniformly over a fraction of the current collector's length, mL_{cc}, with a time-averaged ohmic drop of w [symbol] ₀/(2mσₛ), where [symbol] ₀ is the uniform current density associated with a unit aliquot.

For the continuous-flow limit (extrapolated to m→0), because the mean cell voltages on charge and discharge approach their respective cut-off voltages, the average polarization scales roughly with the magnitude of the voltage cut-off window [FIG. 8(b)]. The extrapolated polarization for continuous flow is a lower bound, because flow-induced impedance ^{14,32} will further increase polarization in the continuous-flow limit. The average polarization computed here for small aliquots agrees well with those predicted for LiCoO₂ and LiFePO₄ under continuous flow at lower C-rates in Ref. 23. For larger aliquot factors, additional effects influence the average polarization, including the specific kinetic and thermodynamic properties of the active material.

The reasons why the discharge energy [FIG. 8(c)] and the energetic efficiency [FIG. 8(d)] should have a maximum near a critical aliquot factor can be explained. Discharge energy is a compromise between reduced charge capacity for larger aliquot factors (m>\tilde{m}) and increased polarization at smaller aliquot factors (m<\tilde{m}). The former process naturally reduces the available discharge capacity for m>\tilde{m}, while the latter process for m<\tilde{m} reduces the mean voltage at which discharge capacity is delivered to the external circuit. In contrast, energetic efficiency has a maximum because the coulombic efficiency is decreased for larger m (due to the transverse dispersion of protruded charged suspension for m>\tilde{m}) and polarization is increased for m<\tilde{m}.

These results also show that the intermittent flow mode can reach higher energetic efficiency and discharge energy than the (conventional) continuous flow mode. The trends in FIG. 8 show why intermittent flow is preferred. Note that even though the smallest aliquot factor simulated explicitly (m=0.125, pseudo-continuous) produces highly uniform SOC distributions within the electroactive region, the detailed analysis we have presented here shows that is has several percent lower energetic efficiency than does operation at the critical aliquot factor [FIG. 8(d)]. In the continuous-flow limit (extrapolated to m→0) energetic efficiency losses for all chemistries are double those achieved by operating at critical aliquot factors (˜10% versus ˜5%, respectively). If flow-induced impedance arises under continuous flow (as reported in Refs. 14,32), efficiency losses under continuous flow will be even larger.

To this point, we have neglected the departure of velocity profiles from the respective limits of plug flow and Newtonian flow without wall slip. Because semi-solid suspensions exhibit a finite yield stress above which shear-thinning behavior is observed,²⁹ their viscoplastic (i.e., rate-dependent, inelastic) rheology is manifested as a variety of velocity profiles under pressure-driven flow conditions. In addition, concentrated suspensions are know to slip at the walls along which they flow,⁵⁵ and this process increases flow uniformity even when the suspension undergoes bulk shear. We introduce a model for viscoplastic flow with wall slip to simulate the influence of (1) wall slip and (2) bulk shear on electrochemical performance. For each of several velocity profiles the critical aliquot factor was determined. Two dimensionless parameters are introduced that embody the coupling of flow profile to material properties (describing both rheology and slip behavior), mean flow velocity, and channel width. Comparing these velocity profiles, each operated at the critical aliquot factor, the highest efficiency is found to occur for plug flow. This is realizable in either the limit of (1) highly slippery interfaces or (2) suspension with large elastic stress relative to viscoplastic contributions.

The effects of slip and viscoplastic flow do not occur independently—they are fluid-mechanically coupled through rheological constitutive and momentum balance equations. Consideration of this coupling is necessary to quantify the efficiency trade-offs between the rheological and transport properties of semi-solid suspensions. Slip can be modeled by a linear velocity/shear-stress relationship u_{w}=βτ_{w} attributed to Navier,⁵⁶ where u_{w} and τ_{w} are velocity and shear stress, respectively, at the channel wall and β is the Navier slip coefficient. Various means can be employed to control the degree of wall slip, including surface roughness^{51,57} and the volume fraction of suspended particles.⁵⁵ We model a simple viscoplastic case, a Bingham fluid, for which viscosity μ varies with shear rate \dot{γ} as μ=μₚ+τ₀/∥\dot{γ}∥, and the flow is rigid (i.e., ∥\dot{γ}∥=0) for shear stresses less than the yield stress τ₀. This rheology exhibits shear-thinning behavior (i.e., viscosity μ decreases monotonically with increasing shear-rate magnitude ∥\dot{γ}∥), with viscosity converging to the material-dependent plastic viscosity μₚ at high shear rates (i.e., μ(∥\dot{γ}∥→∞)=μₚ). The pressure-driven (i.e., Poiseuille) velocity profiles of these fluids are governed by momentum balance, and their shape is uniform where rigid, and quadratic in space where flowing (see analysis in Refs. 52,55,58). The critical aliquot factor for a given velocity profile depends on two dimensionless numbers: the Bingham number [Bn=τ₀w/(2μₚū)], and the slip number (Sl=2μₚβ/w). Bn is a characteristic scale of elastic shear stresses (given by yield stress τ₀) relative to the characteristic contribution from viscoplastic stress (given by 2μₚū/w). Sl is a measure of the flow's slipperiness and is the ratio of the slip extrapolation length (see Ref. 59) to the channel's half-width in the high-velocity limit (Bn→0).

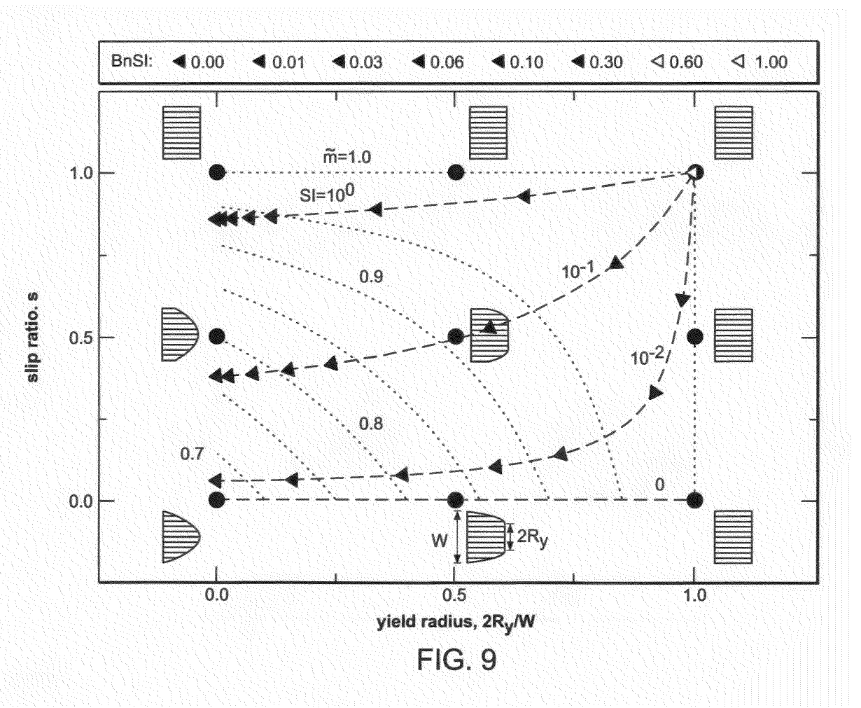

FIG. 9 shows the space of suspension displacement profiles (i.e., path of suspension parcels during an intermittent flow pulse) for a Bingham plastic with slip when displaced at a critical aliquot factor corresponding to the particular velocity profile. Each displacement profile is described geometrically by the flow's yield radius R_{y} (half the width of the flow's rigid core) and the slip ratio s (ratio of the slip velocity u_{w} to the mean velocity ū). For a fixed yield radius R_{y} the displacement profile becomes more plug-like as the slip ratio s increases (i.e., along a vertically ascending line on FIG. 9). For a fixed slip ratio s the displacement profile becomes plug-like as the yield radius R_{y} increases (i.e., along a horizontal line moving rightward on FIG. 9).

The slip ratio s and yield radius R_{y} depend on the Bingham number Bn and slip number Sl. In other words, for each point defined by (R_{y},s) on the displacement profile map (FIG. 9) there corresponds a pair (Bn,Sl). For a particular slip number Sl, the yield radius R_{y} and slip ratio s evolve as Bingham number Bn is varied (FIG. 9, black-dashed lines). FIG. 9 shows such curves for several slip numbers (0, 10⁻², 10⁻¹, and 10⁰). Points are marked along each constant-Sl curve by triangular symbols that indicate the corresponding Bingham number Bn (see FIG. 9, legend). These curves can be thought of as “flow curves” along which volumetric flow-rate is adjusted continuously, because an increase in Bingham number Bn is equivalent to a decrease in mean flow velocity ū when material properties and channel width are fixed. For a given constant-Sl curve, both yield radius R_{y} and slip ratio s increase with increasing Bingham number Bn, i.e., flow uniformity increases with increasing Bn.

The set of possible velocity profiles for Bingham-plastic flow with slip comprise a two-dimensional space (FIG. 9). Superimposed on this map are red-dotted curves along which critical aliquot factor \tilde{m} [defined for each point on the map by Eq. (14)] is constant; the particular curves shown in FIG. 9 are for \tilde{m} equal to 0.70, 0.75, 0.80, 0.85, 0.90, 0.95, and 1.00. Thus, given a specific velocity profile (determined by Bingham number Bn and slip number Sl) a critical aliquot factor that maximizes discharge capacity and energetic efficiency can be determined. For all subsequent results, the aliquot factor was adjusted to its critical value based on its coupling to Bingham number Bn and slip number Sl. Specifically, the electrochemical performance of cells operated in two limits of flow is explored with (1) various degrees of slipperiness (specified by Sl) in the high-velocity limit (Bn=0) and (2) various mean velocities (specified by Bn) in the absence of wall slip (Sl=0). A 7-aliquot flow cell cycling the total system's suspension was simulated. The simulated pumping sequence can be viewed in Video S5 for the LiFePO₄-based suspension with Sl=0 and Bn=0.

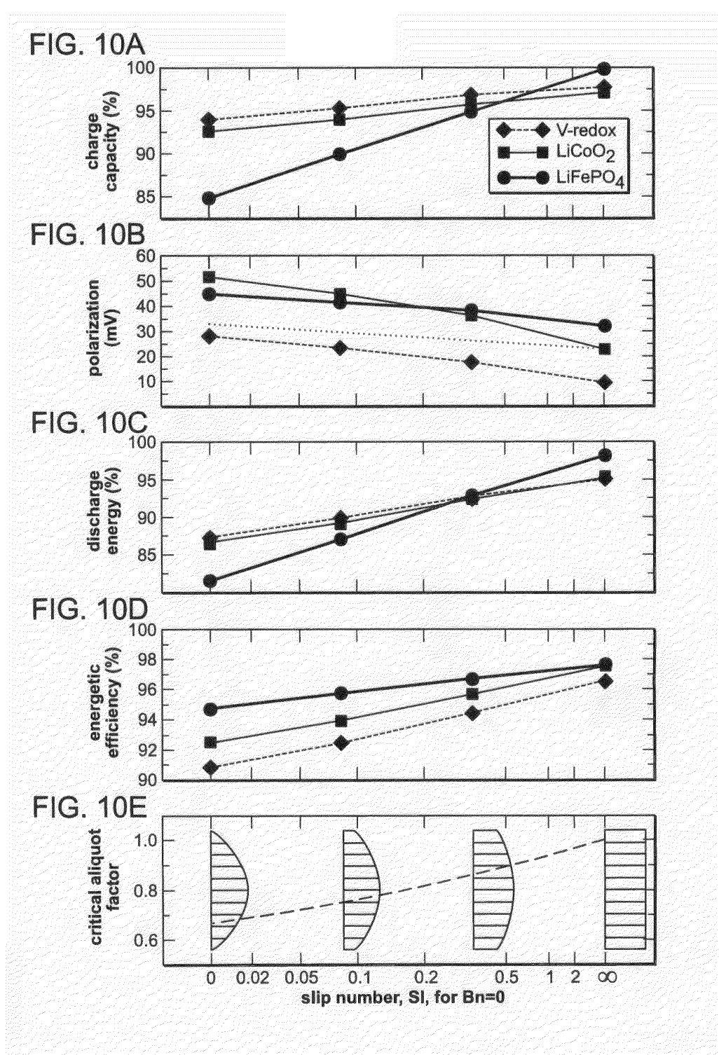

FIG. 10 shows that as the slip number Sl increases for Bn=0, all performance metrics are systematically improved. We see that with strong slip (Sl→∞, ideal plug flow), the discharge energy [FIG. 10(c)] exceeds 95% of the theoretical value for all three chemistries, whereas without slip [FIG. 19(c), Sl=0], values are 81-87% depending on chemistry. A reduced difference is seen in the energetic efficiency, which ranges 96-97% among the three chemistries as Sl→∞[FIG. 10(d)], compared to 91-95% without slip [FIG. 10(d), Sl=0]. Thus, increased slip number reduces energetic efficiency losses by, at most, half relative to the Newtonian case without slip (Sl=0). Though the limit of infinite slip number is unachievable in practice, our results demonstrate that for Sl>2 energetic efficiency can be realized within 1% of that for a perfecting slipping suspension. Expressed in terms of material properties and channel width, this condition is β>w/μₚ. This result shows that the slip coefficient to achieve a sufficient level of energetic efficiency depends on the channel's size and rheology.

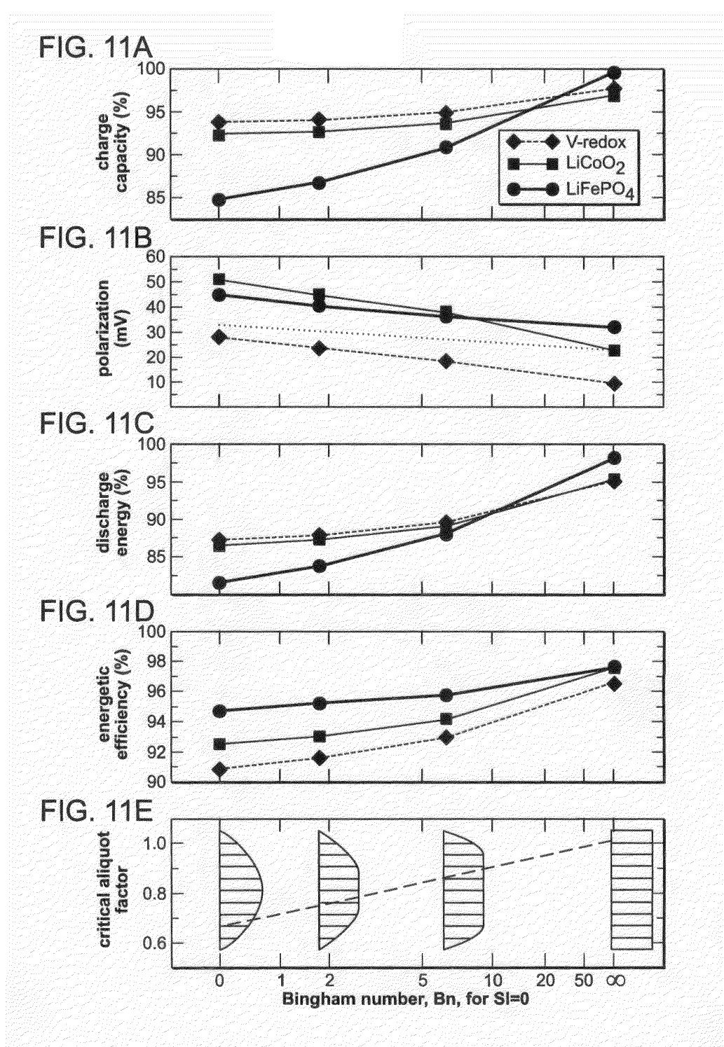

In like manner, FIG. 11 shows that as Bingham number Bn increases for Sl=0, all performance metrics are systematically improved. In the slow-flow limit (Bn→∞) plug flow is realized with high discharge energy and energetic efficiency. Infinitesimally slow flow is impractical, because the time-scale of flow pulses should be short relative to the charge/discharge time in order to be truly “intermittent,” as is the objective in this work. Our results demonstrate that for Bn>50 energetic efficiency can be realized within 1% of that for plug flow. Expressed in terms of material properties, mean velocity, and channel width, this condition is τ₀>100μₚū/w. This result shows that the yield stress to achieve a sufficient level of energetic efficiency depends on the suspension's plastic viscosity, mean velocity, and channel size. In practice, a certain amount of yield stress is optimal, because mechanical energy dissipation increases with increasing yield stress.

Maximizing efficiency is essential to the practical utilization of energy-dense flow batteries for large-scale energy storage. A model of electrochemical kinetics and flow was developed to identify operating conditions and rheological behavior that maximize electrochemical performance. The results suggest that electrochemical efficiency can be maximized through (1) flow volume control, (2) tailoring of suspension rheology, (3) promotion of interfacial slip, and (4) selection of active-material thermodynamics. Precisely tuned flow volumes, large yield stresses, large Navier slip coefficients, and two-phase-like active-materials produce the greatest electrochemical efficiencies. These considerations provide a critical aliquot size for intermittent flow mode operation. Three active-material systems were modeled (LiFePO₄, LiCoO₂, and V-redox). In the worst case (unit aliquots of Newtonian flow in the absence of slip), coulombic and energetic efficiencies can be as low as 80%. However, by flowing critically-sized aliquots in a plug-like manner, discharge energy as a percentage of the theoretical value, and energetic efficiency, can both exceed 95%.

Understanding the present results in the wider context of design and operational constraints of suspension-based flow batteries is essential to their useful integration in scaled devices:
The tradeoff between losses due to electrochemical processes and due to mechanical processes must be accounted in the practical design of flow cells and materials-engineering of suspensions. The incorporation of slippery surfaces is expected to have auxiliary benefits for flow cell operation, including (1) reduction of flow resistance that will reduce mechanical energy losses and (2) minimization of microstructural rearrangement³¹ that can have deleterious effects in suspension-based flow cells. Though high yield stress may be beneficial to electrochemical performance by inducing plug flow (which maintains microstructure), such a strategy will increase the mechanical energy required to pump suspensions.
Slip promotion strategies (e.g., with surface roughness^{51,57}) are beneficial but electrical continuity between the suspension and current collector must be considered.
We have shown that an intermittent flow mode maximizes electrochemical efficiency relative to the continuous flow mode employed in conventional flow batteries based on redox solutions. This flow mode has been demonstrated at the lab-scale,^{5,9} but specialized pumps, flow-control systems, and appropriate stack-design will be required to facilitate the intermittent flow of suspensions in practice.
While the width of the equilibrium voltage plateau is identified as a key design parameter in this work, the choice of active material will depend on additional criteria. Key factors include the intrinsic capacity, efficiency, and cycle life, as well as the open-circuit potential of the chosen electrode couple.

The present invention may be used with other electrochemical devices that use slurry electrodes such as zinc/air batteries, copper etching and recovery, coal oxidation, electro-catalysis, photochemical cells and capacitive deionization.

The contents of all of the references listed herein are incorporated herein by reference in their entirety.

It is recognized that modifications and variations of the present invention will occur to those of ordinary skill in the art and it is intended that all such modifications and variations be included within the scope of the appended claims.

### REFERENCES

1. G. Crabtree et al., Integrating Renewable Electricity on the Grid, American Physical Society, (2010) http://www.aps.org/policy/reports/popa-reports/upload/integratingelec.pdf.

2. J. Ever and G. Corey, Energy Storage for the Electricity Grid: Benefits and Market Potential Assessment Guide, Saudia National Laboratories, (2010).

3. B. Dunn, H. Kamath, and J.-M. Tarascon, Science, 334, 928-935 (2011).

4. Z. Yang et. al., Chem. Rev., 111, 3577-3613 (2011).

5. M. Duduta et al., Adv. Energy Mater., 1, 511-516 (2011).

6. Y. Lu, J. B. Goodenough, and Y. Kim, J. Am. Chem. Soc., 133, 5756-5759 (2011).

7. Y. Yang, G. Zheng, and Y. Cui, Energy Environ. Sci., 6, 1552-1558 (2013).

8. V. E. Brunini, Y.-M. Chiang, and W. C. Carter, Electrochimica Acta, 69, 301-307 (2012).

9. Z. Li et al., Phys. Chem. Chem. Phys., 15, 15833-15839 (2013).

10. S. Hamelet et al., J. Electrochem. Soc., 159, A1360-A1367 (2012).

11. S. Hamelet, D. Larcher, L. Dupont, and J.-M. Tarascon, J. Electrochem. Soc., 160. A516-A520 (2013).

12. V. Preaser et al., Adv. Energy Mater., 2, 895-902 (2012).

13. J. W. Campos et al., Electrochimica Acta, 98, 123-130 (2013).

14. C. R. Dennison et al., J. Power Sources, 247, 489-496 (2014).

15. W. Wang et al., Adv. Funct. Mater., 23, 970-986 (2013).

16. P. Leung et al., RSC Adv., 2, 10125-10156 (2012).

17. Y. M. Chiang, W. C. Carter, B. Ho, and M. Duduta, Int'l Patent Application No. WO2009151639A1, (2009).

18. W. C. Carter, Y.-M. Chiang, M. Duduta, and P. Limthongkul, Int'l Patent Application No. WO2012083233A1, (2012).

19. Q. Liu et al., Electrochem. Commun., 12, 1634-1637 (2010).

20. A. E. S. Sleightholme et al., J. Power Sources, 196, 5742-5745 (2011).

21. Q. Liu, A. E. S. Sleightholme, A. A. Shinkle, Y. Li, and L. T. Thompson, Electrochem. Commun., 11, 2312-2315 (2009).

22. A. Manthiram, Y. Fu, and Y.-S. Su, Acc. Chem. Res., 46, 1125-1134 (2013).

23. K. C. Smith, V. E. Brunini, Y. Dong, Y.-M. Chiang, and W. C. Carter, unpublished work.

24. A. K. Padhi, K. S. Nanjundaswamy, and J. B. Goodenough, J. Electrochem. Soc., 144, 1188-1194 (1997).

25. K. Mizushima, P. C. Jones, P. J. Wiseman, and J. B. Goodenough, Mater. Res. Bull., 15, 783-789 (1980).

26. J. N. Reimers and J. R. Dahn, J. Electrochem. Soc., 139, 2091-2097 (1992).

27. L. O. Valoen and J. N Reimers, J. Electrochem. Soc., 152, A882-A891 (2005).

28. A. A. Shah, M. J. Watt-Smith, and F. C. Walsh, Electrochimica Acta, 53, 8087-8100 (2008).

29. S. Kim et al., Phys. Chem. Chem. Phys., 13, 18186-18193 (2011).

30. J. S. Newman, Electrochemical systems, 2nd ed., p. 560, Prentice Hall, Englewood Cliffs, N.J. (1991).

31. B. Ho, Ph. D. Thesis. Massachusetts Institute of Technology (2012).

32. M. Youssry et al., Phys. Chem. Chem. Phys., 15, 14476 (2013).

33. A. S. Negi and C. O. Osuji, Phys. Rev. E, 80, 010404 (2009).

34. R. Amin, J. Maier, P. Balaya, D. P. Chen, and C. T. Lin, Solid State Ion., 179, 1683-1687 (2008).

35. K. Dokko et al., J. Electrochem. Soc., 148, A422-A426 (2001).

36. M. Safari and C. Delacourt, J. Electrochem. Soc., 158, A63-A73 (2011).

37. T.-S. Dao, C. P. Vyasarayani, and J. McPhee, J. Power Sources, 198, 329-337 (2012).

38. T. Yamamura, N. Watanabe, T. Yano, and Y. Shiokawa, J. Electrochem. Soc., 152, A830-A836 (2005).

39. U. S. Kasavajjula, C. Wang, and P. E. Arce, J. Electrochem. Soc., 155, A866-A874 (2008).

40. Q. Zhang, Q. Guo, and R. E. White, J. Power Sources, 165, 427-435 (2007).

41. M. Pourbaix, Atlas of electrochemical equilibria in aqueous solutions, (1974).

42. K. E. Thomas, J. S. Newman, and R. M. Darling, in Advances in Lithium-Ion Batteries, p. 354, Kluwer Academic/Plenum Publishers (2002).

43. N. Meethong, Y.-H. Kao, S. A. Speakman, and Y.-M. Chiang, Adv. Funct. Mater., 19, 1060-1070 (2009).

44. M. Taniguchi, D. Tashima, and M. Otsubo, in Conference on Electrical Insulation and Dielectric Phenomena, 2007, p. 396-399 (2007).

45. W. M. Hess and C. R. Herd, in Carbon black: science and technology., Dekker, N.Y. (1993).

46. S. Patankar, Numerical Heat Transfer and Fluid Flow, 1st ed., p. 214, Taylor & Francis, (1980).

47. Y. Notay, AGMG software and documentation http://homepages.ulb.ac.be/˜ynotay/AGMG.

48. Y. Notay, Electron. Trans. Numer. Anal., 37, 123-146 (2010).

49. A. Napov and Y. Notay, SIAM J Sci Comput, 34, A1079-A1109 (2012).

50. Y. Notay, SIAM J Sci Comput, 34, A2288-A2316 (2012).

51. R. Buscall, J. I. McGowan, and A. J. Morton-Jones, J. Rheol., 37, 621-641 (1993).

52. A. Fredrickson and R. B. Bird, Ind. Eng. Chem., 50, 347-352 (1958).

53. J. M. Kooijman and D. C. Van Zanten, Chem. Eng. J., 4, 185-188 (1972). (2005).

54. R. F. Probstein, Physicochemical hydrodynamics: an introduction, Wiley-Interscience, (2005).

55. D. M. Kalyon, J. Rheol., 49, 621-640 (2005).

56. W. R. Schowalter, J. Non-Newton. Fluid Mech., 29, 25-36 (1988).

57. H. A. Barnes, J. Non-Newton. Fluid Mech., 56, 221-251 (1995).

58. E. J. Fordham, S. H. Bittleston, and M. A. Tehrani, Ind. Eng. Chem. Res., 30, 517-524 (1991).

59. F. Brochard and P. G. De Gennes, Langmuir, 8, 3033-3037 (1992).

1. Flow battery comprising:
high energy density fluid electrodes having a selected non-Newtonian rheology; and structure for providing intermittent flow pulses of controlled volume and duration of the fluid electrodes, the structure adapted to promote interfacial slip to improve flow uniformity.

2. The battery of claim 1 wherein the fluid electrodes are suspension.

3. The battery of claim 1 wherein the controlled volume is a critical aliquot for intermittent flow mode operation.

4. The battery of claim 1 wherein surface roughness, textures, or patterns are selected to promote slip.

5. The battery of claim 2 wherein the suspensions contain active materials or conductive networks in redox solutions.

6. Flow battery comprising:
fluid electrodes including solutions or suspensions; and
structure for providing flow of the solutions or suspensions, the structure including a slippery surface to reduce flow resistance to reduce mechanical energy loss or to minimize microstructural rearrangement.

7. Electrochemical device comprising:
slurry electrodes; and
structure for providing flow of the slurry, the structure including a slippery surface to reduce flow resistance.

8. The device of claim 7 selected from the group consisting of zinc/air battery, for etching copper, to perform coal oxidation, to perform electro-calalysis, a photochemical cell and capacitive deionization.
